(19) United States
(12) Patent Application Publication
(10) Pub. No.: US 2014/0168858 A1
(43) Pub. Date: Jun. 19, 2014

(54) ELECTROCONDUCTIVE POLYMER SOLUTION AND METHOD FOR PRODUCING THE SAME, ELECTROCONDUCTIVE POLYMER MATERIAL, AND SOLID ELECTROLYTIC CAPACITOR

(71) Applicant: NEC TOKIN Corporation, Sendai-shi (JP)

(72) Inventors: Hiroki SATOH, Sendai-shi (JP); Yasuhisa Sugawara, Sendai-shi (JP); Hiroyuki Demizu, Sendai-shi (JP); Yasuhiro Tomioka, Sendai-shi (JP); Koji Sakata, Sendai-shi (JP)

(73) Assignee: NEC TOKIN Corporation, Sendai-shi (JP)

(21) Appl. No.: 14/107,653

(22) Filed: Dec. 16, 2013

(30) Foreign Application Priority Data
Dec. 17, 2012 (JP) 2012-274553

(51) Int. Cl. H01G 9/028

(52) U.S. Cl. CPC H01G 9/028
USPC 361/527; 252/62.2

(57) ABSTRACT

Provided is an electroconductive polymer solution containing an electroconductive polymer having high chemical resistance and a high electroconductivity. It is an electroconductive polymer solution, containing an electroconductive polymer having thiophene, aniline, pyrrole, or a derivative thereof as a repeating unit, wherein a dopant or a salt thereof having an amide bond and an anion group is doped into the electroconductive polymer.

This application is based upon and claims the benefit of priority from Japanese patent application No. 2012-274553, filed on Dec. 17, 2012, the disclosure of which is incorporated herein in its entirety by reference.

### TECHNICAL FIELD

The present invention relates to an electroconductive polymer solution, an electroconductive polymer material obtained from the electroconductive polymer solution, and a solid electrolytic capacitor using the electroconductive polymer material as a solid electrolyte.

### BACKGROUND ART

A dielectric oxide film is formed on a porous body of a valve metal such as tantalum or aluminum by anodic oxidation method, and thereafter an electroconductive polymer layer is formed on this oxide film, and a solid electrolytic capacitor in which this is used as a solid electrolyte is developed.

The method for forming the electroconductive polymer layer which comes to be a solid electrolyte of this solid electrolytic capacitor is broadly classified into chemical oxidation polymerization and electrolytic oxidation polymerization. As the monomer (monomer) composed of the electroconductive polymer, pyrrole, thiophene, 3,4-ethylenedioxythiophene, and aniline are known.

These solid electrolytic capacitors have a low equivalent series resistance (hereinafter, referred to as ESR) in comparison with a condenser using manganese dioxide as a solid electrolyte, and begin to be used for various purposes. Also, in late years, with a trend of high frequency and large current of integrated circuit, a solid electrolytic capacitor having a low ESR, a large capacity, and a low loss is required.

Patent documents 1 to 5 disclose an electroconductive polymer obtained by doping a polyanion as a dopant into a polythiophene. On the other hand, Patent document 6 discloses a sulfonation method of a polystyrene.

### PRIOR ART DOCUMENT

### Patent Document

Patent document 1: JP 4991208 B2

Patent document 2: JP 2011-63820 A

Patent document 3: JP 2011-523427 A

Patent document 4: WO 2009/131012 A1

Patent document 5: JP 07-90060 A

Patent document 6: JP 05-82401 B2

### SUMMARY OF THE INVENTION

### Problem to be Solved by the Invention

However, the electroconductive polymers disclosed in Patent documents 1 to 5 have low chemical resistance and, in particular, is easily dissolved in a hydrocarbon solvent. Also, the electroconductivity of the electroconductive polymer is insufficient. Further, if the electroconductive polymer is used as a solid electrolyte of the solid electrolytic capacitor, the ESR is high.

The object of the present invention is to provide an electroconductive polymer solution containing an electroconductive polymer having high chemical resistance and a high electroconductivity. Also, it is to provide a solid electrolytic capacitor having a low ESR.

### Means of Solving the Problem

The electroconductive polymer solution according to the present invention is an electroconductive polymer solution, containing an electroconductive polymer having thiophene, aniline, pyrrole, or a derivative thereof as a repeating unit, wherein a dopant or a salt thereof having an amide bond and an anion group is doped into the electroconductive polymer.

The electroconductive polymer material according to the present invention is obtained by drying the electroconductive polymer solution according to the present invention.

The solid electrolytic capacitor according to the present invention has a solid electrolyte layer containing the electroconductive polymer material according to the present invention.

The method for producing an electroconductive polymer solution according to the present invention includes carrying out an oxidation polymerization of thiophene, aniline, pyrrole, or a derivative thereof in water or in an aqueous solution containing water and a water-miscible solvent in the presence of a dopant or a salt thereof having an amide bond and an anion group.

The method for producing an electroconductive polymer solution according to the present invention, including: obtaining electroconductive polymer (P1) by an oxidation polymerization of thiophene, aniline, pyrrole, or a derivative thereof in a solution containing a low-molecular organic acid or a salt thereof that is a dopant; purifying electroconductive polymer (P1); and obtaining an electroconductive polymer solution by mixing purified electroconductive polymer (P1) and oxidant (O2) in a solution containing a dopant or a salt thereof having an amide bond and an anion group.

### Effect of the Invention

According to the present invention, an electroconductive polymer solution containing an electroconductive polymer having high chemical resistance and a high electroconductivity can be provided. Also, a solid electrolytic capacitor having a low ESR can be provided.

### BRIEF DESCRIPTION OF DRAWING

FIG. 1 is a schematic sectional view showing a conformation of a solid electrolytic capacitor according to one embodiment of the present invention.

### MODE FOR CARRYING OUT THE INVENTION

### [Electroconductive Polymer Solution]

The electroconductive polymer solution according to the present invention is an electroconductive polymer solution which contains an electroconductive polymer having thiophene, aniline, pyrrole, or a derivative thereof as a repeating unit, in which a dopant or a salt thereof having an amide bond and an anion group is doped into the electroconductive polymer.

The chemical resistances of the electroconductive polymers disclosed in Patent documents 1 to 5 are insufficient. In particular, the poly(3,4-ethylenedioxythiophene) into which a polystyrene sulfonic acid is doped as a dopant (hereinafter, referred to as PEDOT/PSS) has a problem that it is easily dissolved in an organic solvent such as hydrocarbon solvent. Since the polystyrene sulfonic acid that is a dopant is produced by sulfonating a polystyrene with an anhydrous sulfonic acid or the like, unreacted polystyrene part remains in the polystyrene sulfonic acid. Also, unsulfonated polystyrene part may be purposely left for the reason of improving humidity resistance or the like. Since the polystyrene part is easily dissolved in an organic solvent such as hydrocarbon solvent, PEDOT/PSS is easily dissolved in an organic solvent such as hydrocarbon solvent. Also, the electroconductivity of the electroconductive polymer using a dopant such as a polystyrene sulfonic acid is insufficient.

In the present invention, as a dopant for an electroconductive polymer having thiophene, aniline, pyrrole, or a derivative thereof as a repeating unit, a dopant or a salt thereof having an amide bond and an anion group is used. By the amide bond in the dopant, the solubility to an organic solvent such as hydrocarbon solvent is decreased, and the chemical resistance is provided. Thereby, the problem that the electroconductive polymer is dissolved by use of an organic solvent such as hydrocarbon solvent in the process can be solved. For example, when it is used for producing a solid electrolytic capacitor, the ESR increase by the dissolution of the electroconductive polymer or the like can be prevented. Also, by the amide bond in the dopant, a hydrogen bond is generated between the skeleton of the dopant, and the crystallinity becomes higher, which leads to improve the electroconductivity. Thereby, when the electroconductive polymer material obtained by drying the electroconductive polymer solution according to the present invention is used for the solid electrolyte of the solid electrolytic capacitor, the ESR is decreased.

Note that, the electroconductive polymer solution in the present invention means a solution in a state where an electroconductive polymer into which the dopant or the salt thereof is doped is dissolved or dispersed in a solvent.

### (Electroconductive Polymer)

The electroconductive polymer according to the present invention has thiophene, aniline, pyrrole, or a derivative thereof as a repeating unit. The electroconductive polymer according to the present invention can be a π-conjugated electroconductive polymer in which many π-conjugated systems having a structure of alternately-located single bonds and double bonds are connected.

For the monomer for forming a repeating unit of the electroconductive polymer, thiophene, aniline, pyrrole, or a derivative thereof can be used. Specific examples of the derivative of thiophene include 3,4-ethylenedioxythiophene or derivatives thereof, 3-alkylthiophene such as 3-hexylthiophene, and 3-alkoxythiophenes such as 3-methoxythiophene. Specific examples of the derivative of aniline include 2-alkylanilines such as 2-methylaniline and 2-alkoxyanilines such as 2-methoxyaniline. Specific examples of the derivative of the pyrrole include 3-alkylpyrroles such as 3-hexylpyrrole, 3,4-dialkylpyrroles such as 3,4-dihexyl pyrrole, 3-alkoxypyrroles such as 3-methoxypyrrole, and 3,4-dialkoxypyrroles such as 3,4-dimethoxypyrrole.

Among the monomers, 3,4-ethylenedioxythiophene or derivatives thereof are preferable. Examples of the derivative of 3,4-ethylenedioxythiophene include 3,4-(1-alkyl)ethylenedioxythiophenes such as 3,4-(1-hexyl)ethylenedioxythiophene. The monomer may be used alone or in combination with two or more kinds.

### (Dopant)

A dopant or a salt thereof having an amide bond and an anion group is doped into the electroconductive polymer according to the present invention.

The dopant having an amide bond and an anion group is not particularly limited. Also, the amide bond contained in the dopant or the salt thereof is not particularly limited. As the amide bond contained in the dopant or the salt thereof having an amide bond and an anion group, for example, carboxylic amide, sulfonamide, or phosphoric amide can be used. This may be used alone or in combination with two or more kinds. Among these, the dopant or the salt thereof is preferably a carboxylic amide. Specifically, examples of the dopant or the salt thereof include copolymers of a monomer containing multivalent amine or derivative thereof (a) and multivalent carboxylic acid or derivative thereof (b), copolymers of a monomer containing a lactam or a derivative thereof, and copolymers of a monomer containing a compound having an anion group and an amino group or a derivative thereof. Among these, it is preferable to use a copolymer of a monomer containing multivalent amine or derivative thereof (a) and multivalent carboxylic acid or derivative thereof (b) because a polyamide having a high polymerization degree can be obtained, also because the property can be easily controlled by the monomer used, and because the crystallinity can also be made higher.

As multivalent amine or derivative thereof (a), any compounds such as aliphatic amine compounds, alicyclic amine compounds, and aromatic amine compounds can be used as long as it is known as a raw material of a polyamide. The valence of the multivalent amine in multivalent amine or derivative thereof (a) is not particularly limited, but it can be, for example, bivalent or trivalent.

Examples of the diamine or the derivative thereof include, for example, 1,3-diaminopropane, 1,4-diaminobutane, 1,5-diaminopentane, 1,6-diaminohexane, 2-methyl-1,5-diaminopentane (MDP), 1,7-diaminoheptane, 1,8-diaminooctane, 1,9-diaminononane, 1,10-diaminodecane, 1,11-diaminoundecane, 1,12-diaminododecane, 1,13-diaminotridecane, 1,14-diaminotetradecane, 1,15-diaminopentadecane, 1,16-diaminohexadecane, 1,17-diaminoheptadecane, 1,18-diaminooctadecane, 1,19-diaminononadecane, 1,20-diaminoeicosane, 4,4′-ethylenediamine, 4,4-isopropylidenediamine, p-phenylenediamine, m-phenylenediamine, o-phenylenediamine, 3,4′-oxydianiline, 4,4′-oxydianiline, 3,3′-sulfonyldianiline, 4,4′-sulfonyldianiline, 1,4-naphthalenediamine, 1,5-naphthalenediamine, 2,6-naphthalenediamine, 1,3-bis(m-aminophenyl)-1,1,3,3-tetramethyldisiloxane, 4,4′-bis(4-aminophenoxy)diphenyl sulfone, 4,4′-bis(3-aminophenoxy)diphenyl sulfone, 4,4′-bis(4-aminophenoxy)benzophenone, 4,4′-bis(3-aminophenoxy)benzophenone, 4,4′-bis(4-aminophenylmercapto)benzophenone, 4,4′-bis(3-aminophenylmercapto)benzophenone, 2,2′-bis[4-(2-trifluoromethyl-4-aminophenoxy)phenyl]hexafluoropropane, 2,2′-bis[4-(3-trifluoromethyl-5-aminophenoxy)phenyl]hexafluoropropane, 2,2′-bis[4-(3-trifluoromethyl-4-aminophenoxy)phenyl]hexafluoropropane, 2,2′-bis[4-(2-trifluoromethyl-5-aminophenoxy)phenyl]hexafluoropropane, 2,2′-bis[4-(4-trifluoromethyl-5-aminophenoxy)phenyl]hexafluoropropane, 2,2′-bis[4-(2-nonafluorobutyl-5-aminophenoxy)phenyl]hexafluoropropane, 2,2′-bis[4-(4-nonafluorobutyl-5-aminophenoxy)phenyl]hexafluoropropane, 4,4′-diaminodiphenylmethane, o-tolidine, o-dianisidine, 2,5-diaminopyridine, 3,3′-dihydroxy-4,4′-diaminobiphenyl, 2,2-bis(4-hydroxy-3-aminophenyl)hexafluoropropane, and derivatives thereof.

Examples of the multivalent amine with a valence of 3 or more or the derivative thereof include, for example, 1,2,4-benzenetriamine. This multivalent amine or the derivative thereof may be used alone or in combination with two or more kinds.

As multivalent carboxylic acid or derivative thereof (b), any compounds such as aliphatic carboxylic acids, alicyclic carboxylic acids, and aromatic carboxylic acids can be used. The valence of the multivalent carboxylic acid in multivalent carboxylic acid or derivative thereof (b) is not particularly limited, but it can be, for example, bivalent or trivalent.

Examples of the dicarboxylic acid or the derivative thereof include, for example, oxalic acid, malonic acid, succinic acid, glutaric acid, adipic acid, pimelic acid, suberic acid, azelaic acid, sebacic acid, undecanedioic acid, dodecanedioic acid, acetylenedicarboxylic acid, fumaric acid, maleic acid, malic acid, oxaloacetic acid, 2-oxoglutaric acid, terephthalic acid, isophthalic acid, o-phthalic acid, 4,4′-biphenyldicarboxylic acid, 3,3′-methylenedibenzoic acid, 4,4′-methylenedibenzoic acid, 4,4′-oxydibenzoic acid, 4,4′-thiodibenzoic acid, 3,3′-carbonyldibenzoic acid, 4,4′-carbonyldibenzoic acid, 4,4′-sulfonyldibenzoic acid, 1,4-naphthalenedicarboxylic acid, 1,5-naphthalenedicarboxylic acid, 2,6-naphthalenedicarboxylic acid, 1,3-cyclohexanedicarboxylic acid, 1,4-cyclohexanedicarboxylic acid, methylmalonic acid, dimethylmalonic acid, phenylmalonic acid, benzylmalonic acid, phenylsuccinic acid, 3-phenylglutaric acid, 1,3-phenylenediacetic acid, 1,4-phenylenediacetic acid, 4-carboxyphenylacetic acid, 5-bromo-N-(carboxymethyl)anthranilic acid, m-carboxycinnamic acid, 5-hydroxyisophthalic acid, 4-hydroxy-2,5-dicarboxy pyridine, and derivatives thereof.

Examples of the multivalent carboxylic acid with a valence of 3 or more or the derivative thereof include, for example, aconitic acid, citric acid, oxalosuccinic acid, 1,2,3-benzenetricarboxylic acid, 1,2,4-benzenetricarboxylic acid, 1,3,5-benzenetricarboxylic acid, benzophenone-2,4,5-tricarboxylic acid, 3-butene-1,2,3-tricarboxylic acid, 1,3,5-cyclohexanetricarboxylic acid, 1,2,4-cyclohexanetricarboxylic acid, 1,3,5-pentanetricarboxylic acid, 2-phosphonobutane-1,2,4-tricarboxylic acid, 1,2,3-propanetricarboxylic acid, and 4-carboxyphthalic anhydride. This multivalent carboxylic acid or the derivative thereof may be used alone or in combination with two or more kinds.

The ratio of multivalent amine or derivative thereof (a) and multivalent carboxylic acid or derivative thereof (b) is not particularly limited. However, in the case of using a diamine and a dicarboxylic acid, for example, it is preferable to use them in equimolar amount from the standpoint that a polyamide containing an anion group having a high polymerization degree can be synthesized. Note that, a polyamide having a small average polymerization degree which is synthesized by making either ratio higher may be used.

Examples of the lactam or the derivative thereof include, for example, ε-caprolactam, enantholactam, ω-laurolactam, and derivatives thereof. This may be used alone or in combination with two or more kinds.

Examples of compound having an anion group and an amino group or derivative thereof (c) include, for example, alanine, glycine, 4-aminobutyric acid, asparagine, aspartic acid, glutamine, glutaminic acid, phenylalanine, 6-aminocaproic acid, 7-aminoheptanoic acid, 8-aminooctanoic acid, 9-aminononanoic acid, aminoethylsulfonic acid, and derivatives thereof. This may be used alone or in combination with two or more kinds.

The dopant or the salt thereof having an amide bond and an anion group is assumed to have an amide bond in at least one of the side chain and the main chain. The position of the amide bond is not particularly limited, but the main chain preferably has an amide bond. In the case where the main chain has an amide bond, a stronger bond can be formed and the chemical resistance is further improved in comparison with the case where only the side chain has an amide bond.

The dopant or the salt thereof having an amide bond and an anion group preferably has a main chain containing an aromatic ring. In the case where the main chain contains an aromatic ring, a π-π interaction is developed, and the crystallinity and the heat resistance of the electroconductive polymer are improved. Also, since the electroconductivity of the electroconductive polymer is improved by the improvement of the crystallinity, when the electroconductive polymer material according to the present invention is used for a solid electrolyte of a solid electrolytic capacitor, the low ESR can be realized.

As the dopant or the salt thereof having an aromatic ring in the main chain, for example, copolymers of a monomer containing an aromatic multivalent amine or a derivative thereof and an aromatic multivalent carboxylic acid or a derivative thereof, copolymers of a monomer containing an aliphatic multivalent amine or a derivative thereof and an aromatic multivalent carboxylic acid or a derivative thereof, copolymers of a monomer containing an aromatic multivalent amine or a derivative thereof and an aliphatic multivalent carboxylic acid or a derivative thereof, and the like can be used. Specifically, copolymers of a monomer containing an aromatic diamine and an aromatic dicarboxylic acid, copolymers of a monomer containing an aliphatic diamine and an aromatic dicarboxylic acid, copolymers of a monomer containing an aromatic diamine and an aliphatic dicarboxylic acid, and the like can be used. Also, these monomers may contain the lactam or the derivative thereof, or compound having an anion group and an amino group or derivative thereof (c).

The ratio of the aromatic ring contained in the main chain is preferably 5% or more, is more preferably 50% or more, and is further preferably 70% or more. Note that, the ratio of the aromatic ring contained in the main chain may be 100%. In the case where the ratio of the aromatic ring contained in the main chain is 5% or more, since a π-π interaction is developed more and since the crystallinity of the electroconductive polymer is increased, the electroconductivity of the electroconductive polymer is improved. Note that, the ratio of the aromatic ring contained in the main chain means a ratio of the number of the repeating unit containing an aromatic ring with respect to the total number of the repeating unit in the dopant or the salt thereof having an amide bond and an anion group. The ratio of the aromatic ring contained in the main chain can be controlled by a compounding ratio of a monomer which contains an aromatic ring and a monomer which does not contain an aromatic ring.

At least a part of the aromatic ring is preferably substituted with an anion group from the standpoint of the dispersibility. The ratio of the aromatic ring substituted by an anion group is preferably 5% or more, is more preferably 20% or more, and is further preferably 80% or more. Note that, the ratio of the aromatic ring substituted by an anion group may be 100%. In the case where the ratio of the aromatic ring substituted by an anion group is 5% or more, the doping ratio is improved and the dispersibility of the electroconductive polymer in the electroconductive polymer solution is also improved. Note that, the ratio of the aromatic ring substituted by an anion group means a ratio of the number of the aromatic ring substituted by an anion group with respect to the total number of the aromatic ring in the main chain. The ratio of the aromatic ring substituted by an anion group can be controlled by a compounding ratio of a monomer in which a part of the aromatic ring is substituted with an anion group and a monomer in which the aromatic ring is not substituted with an anion group.

Also, the main chain of the dopant or the salt thereof having an amide bond and an anion group may contain another main chain which can be copolymerized.

The anion group of the dopant or the salt thereof having an amide bond and an anion group is not particularly limited, but examples thereof include, for example, functional groups such as sulfo group, carboxyl group, phosphoric acid group, mono-substituted sulfate group, and mono-substituted phosphate group. Among these, sulfo group, phosphate group, and carboxyl group are preferable for the anion group from the standpoint that it is easily doped. The content of the anion group of the dopant or the salt thereof having an amide bond and an anion group is not particularly limited. However, from the standpoint that the water-soluble property can be given and that the doping ratio into the electroconductive polymer can be improved, the ratio of the number of the repeating unit containing an anion group with respect to the total number of the repeating unit in the dopant or the salt thereof having an amide bond and an anion group is preferably 5% or more, is more preferably 20% or more, and is further preferably 80% or more. Note that, the ratio may be 100%. Also, the ratio can be controlled by a compounding ratio of a monomer which contains an anion group except for the anion group for forming an amide bond and a monomer which does not contain an anion group except for the anion group for forming an amide bond.

Also, a substituent except for the anion group may be contains, and the kind is not particularly limited. Examples thereof include, for example, alkyl groups, hydroxy group, cyano group, phenyl group, phenol group, ester groups, alkoxy groups, carbonyl group, and amino group.

The weight average molecular weight of the dopant or the salt thereof having an amide bond and an anion group is preferably 1000 to 5000000, is more preferably 2000 to 1000000, and is further preferably 2500 to 600000. When the weight average molecular weight is 1000 or more, the sufficient electroconductivity can be obtained. Also, when the weight average molecular weight is 5000000 or less, the viscosity of the solution can be decreased. Note that, the weight average molecular weight is a value measured by chromatography method.

The method for producing the dopant or the salt thereof having an amide bond and an anion group is not particularly limited. Examples thereof include, for example, a method by a melt polymerization of a carboxylic acid and an amine in the case where the dopant or the salt thereof is a carboxylic amide, a method by a reaction of an acid chloride having an improved reactivity of a carboxylic acid and an activated amide with a nucleophile, and a method by a reaction of a carboxylic acid as an activated acylate with a nucleophile. Examples thereof include, for example, a method disclosed in JP 2745381 B2. Also, for example, in the case of using a lactam or a derivative thereof, caprolactam is ring-opened by hydrolysis in the presence of water under a pressure of 20 kg/cm²G or less, preferably 3 to 10 kg/cm²G at a temperature of 240 to 290° C. After that, the pressure is relieved, and a polycondensation can be carried out at the similar temperature under normal pressure or a reduced pressure to several kPa to produce a polyamide. Also, in the case of using a compound having an anion group and an amino group or a derivative thereof, a known technology can be used. Examples thereof include, for example, the following methods.

1. An N-protected compound having an anion group and an amino group (the protecting group is generally t-butoxycarbonyl) is bonded to a solid insoluble carrier (in general, a polystyrene resin) through a bonding group (in general, benzyl ester) by the carboxyl terminal.
2. An N-protecting group is separated and removed by a method by which a compound having an anion group and an amino group is not detached from the carrier, and a second N-protected compound having an anion group and an amino group is bonded to the compound which has been already bonded (in general by using a carbodiimide coupling agent).
3. A repeating unit of a desired compound having an anion group and an amino group is formed, and the operation is further repeated by using an N-protected compound having an anion group and an amino group which is necessary to be bonded to the carrier by the anion terminal.
4. The final N-protecting group is removed, and the compound having an anion group and an amino group is separated from the carrier by a dissociation of the bonding group (in general, by using a strong acid).

### (Polystyrene Sulfonic Acid)

It is preferable that the electroconductive polymer solution according to the present invention further contains a polystyrene sulfonic acid from the standpoint of dispersibility. The weight average molecular weight of the polystyrene sulfonic acid is not particularly limited, but can be, for example, 2000 to 500000. The content of the polystyrene sulfonic acid in the electroconductive polymer solution is not particularly limited, but can be, for example, 0.001 mass % or more and 1000 mass % or less with respect to 100 mass % of the dopant or the salt thereof having an amide bond and an anion group. This is because the dispersibility may not sufficiently be shown when it is less than 0.001 mass %, and because the chemical resistance may be lowered when it is more than 1000 mass %. It is more preferably 0.1 to 100 mass % with respect to 100 mass % of the dopant or the salt thereof having an amide bond and an anion group.

### (Solvent)

The solvent contained in the electroconductive polymer solution according to the present invention is preferably water, but may be a mixed solvent containing water and a water-soluble organic solvent. Specific examples of the water-soluble organic solvent include protic polarity solvents such as methanol, ethanol, propanol, and acetic acid; and aprotic polar solvents such as N,N-dimethylformamide, dimethyl sulfoxide, acetonitrile, and acetone. Among these, aprotic polar solvents are preferable from the standpoint of electroconductivity for the water-soluble organic solvent, and dimethylsulfoxide is more preferable. This may be used alone or in combination with two or more kinds.

### (Binder)

To the electroconductive polymer solution according to the present invention, a resin having a bonding function may be added as a binder from the standpoint of film intensity and bonding property to the capacitor. Specific examples of the resin include polyester resins, polyamide resins, polyimide resins, polyether resins, polystyrene resins, polyurethane resins or the modified bodies. This may be used alone or in combination with two or more kinds. The content of the resin in the electroconductive polymer solution is preferably 0.01 to 20 parts by mass with respect to 100 parts by mass of the electroconductive polymer solution from the standpoint of preventing the decrease of the electroconductivity.

### [Method for Producing Electroconductive Polymer Solution]

The method for producing the electroconductive polymer solution according to the present invention includes carrying out an oxidation polymerization of thiophene, aniline, pyrrole, or a derivative thereof in water or in an aqueous solution containing water and a water-miscible solvent in the presence of a dopant or a salt thereof having an amide bond and an anion group.

Also, the method for producing the electroconductive polymer solution according to the present invention includes obtaining electroconductive polymer (P1) by an oxidation polymerization of thiophene, aniline, pyrrole, or a derivative thereof in a solution containing a low-molecular organic acid or a salt thereof that is a dopant; purifying electroconductive polymer (P1); and obtaining an electroconductive polymer solution by mixing purified electroconductive polymer (P1) and oxidant (O2) in a solution containing a dopant or a salt thereof having an amide bond and an anion group.

By synthesizing electroconductive polymer (P1), thereafter by purifying it, and by mixing electroconductive polymer (P1) and oxidant (O2) in a solution containing a dopant or a salt thereof having an amide bond and an anion group, the monomer and the oxidant that comes to be an impurity is removed from electroconductive polymer (P1), and thereby an electroconductive polymer having high purity can be obtained. Note that, “purification” specifically means to remove the dopant, monomer (M1), oxidant (O1), and an oxidant after the reaction by separating and washing electroconductive polymer (P1) from a reaction liquid containing electroconductive polymer (P1) obtained by an oxidation polymerization. The washing is preferably carried out using a solvent in which monomer (M1) and/or oxidant (O1) can be dissolved and in which electroconductive polymer (P1) is not dissolved. Specific examples of the washing solvent include water and alcohol solvents such as methanol, ethanol, and propanol. The washing solvent may be used alone or in combination with two or more kinds. The washing degree can be confirmed by pH measurement or colorimetry observation of the washing solvent after washing.

Specific examples of the low-molecular organic acid or a salt thereof that is a dopant include alkyl sulfonic acid, benzenesulfonic acid, naphthalenesulfonic acid, anthraquinonesulfonic acid, camphorsulfonic acid, and derivatives thereof, and an iron (III) salt thereof. The low molecular organic acid may be a monosulfonic acid, a disulfonic acid, or a trisulfonic acid. Specific examples of the derivative of benzenesulfonic acid include phenolsulfonic acid, styrenesulfonic acid, toluenesulfonic acid, and dodecylbenzenesulfonic acid. Specific examples of the derivative of naphthalenesulfonic acid include 1-naphthalenesulfonic acid, 2-naphthalenesulfonic acid, 1,3-naphthalenedisulfonic acid, 1,3,6-naphthalenetrisulfonic acid, and 6-ethyl-1-naphthalenesulfonic acid. Specific examples of the derivative of anthraquinonesulfonic acid include anthraquinone-1-sulfonic acid, anthraquinone-2-sulfonic acid, anthraquinone-2,6-disulfonic acid, and 2-methylanthraquinone-6-sulfonic acid. Among these, 1-naphthalenesulfonic acid, 2-naphthalenesulfonic acid, 1,3,6-naphthalenetrisulfonic acid, anthraquinonedisulfonic acid, p-toluenesulfonic acid, camphorsulfonic acid, or an iron (III) salt thereof is preferable. Camphorsulfonic acid is more preferable because the influence on high crystallization of the polymer is large. Camphorsulfonic acid may be an optically active material. Also, iron (III) p-toluenesulfonate is also preferable because it has a property combining with a function of an oxidant. The dopant may be used alone or in combination with two or more kinds. The amount of the dopant used is not particularly limited, but is preferably 1 to 100 parts by mass with respect to 1 part by mass of thiophene, aniline, pyrrole, or a derivative thereof from the standpoint of obtaining an electroconductive polymer having a high electroconductivity, and is more preferably 1 to 20 parts by mass.

The oxidant used for the polymerization is not particularly limited, and it is possible to use iron (III) salts of an inorganic acid such as iron (III) chloride hexahydrate, anhydrous iron (III) chloride, iron (III) nitrate nonahydrate, anhydrous ferric nitrate, iron (III) sulfate n-hydrate (n=3 to 12), ammonium iron (III) sulfate dodecahydrate, iron (III) perchlorate n-hydrate (n=1, 6), and iron (III) tetrafluoroborate; copper (II) salts of an inorganic acid such as copper (II) chloride, copper (II) sulfate, and copper (II) tetrafluoroborate; nitrosonium tetrafluoroborate; salts of a persulfate such as ammonium persulfate, sodium persulfate, and potassium persulfate; salts of a periodate such as potassium periodate; hydrogen peroxide, ozone, potassium hexacyanoferrate (III), tetraammonium cerium (IV) sulfate dihydrate, bromine, and iodine; and iron (III) salts of an organic acid such as iron (III) p-toluenesulfonate. Among these, an iron salt (III) of an inorganic acid or an organic acid, or a persulfate is preferable, and ammonium persulfate or iron (III) p-toluenesulfonate is more preferable. In particular, iron (III) p-toluenesulfonate is preferable because it has a property combining with an organic acid dopant. This oxidant may be used alone or in combination with two or more kinds. The amount of the oxidant used is not particularly limited, but is preferably 0.5 to 100 parts by mass with respect to 1 part by mass of thiophene, aniline, pyrrole, or a derivative thereof from the standpoint of obtaining a polymer having a high electroconductivity by a reaction under a milder oxidation atmosphere, and is more preferably 1 to 40 parts by mass.

The concentration of thiophene, aniline, pyrrole or a derivative thereof in the reaction solution is not particularly limited, but is preferably 0.5 to 70 mass %, from the standpoint of obtaining an electroconductive polymer having a high electroconductivity in good yield, and is more preferably 1 to 50 mass %.

As the oxidation polymerization, any of the chemical oxidation polymerization and the electrolytic oxidation polymerization can be adopted.

In the case of carrying out a chemical oxidation polymerization, the temperature at the time of the polymerization is not particularly limited, but is preferably 0 to 100° C. at which water is a liquid state, and is more preferably 0 to 30° C. Also, the polymerization time is preferably 1 hour to 72 hours, and is more preferably 6 hours to 48 hours.

Examples of the method other than that described above include a method by an oxidation polymerization of thiophene, aniline, pyrrole, or a derivative thereof in the presence of a polystyrene sulfonic acid, another polyacid, a low molecular acid, or a salt thereof, and thereafter by an oxidation polymerization of a thiophene, aniline, pyrrole, or a derivative thereof in the presence of a dopant or a salt thereof having an amide bond and an anion group.

Also, it includes a method by an oxidation polymerization of a thiophene, aniline, pyrrole, or a derivative thereof in the presence of a dopant or a salt thereof having an amide bond and an anion group, and thereafter by an oxidation polymerization using a polystyrene sulfonic acid, another polyacid, a low molecular acid, or a salt thereof.

Also, by mixing the electroconductive polymer obtained by the method, an electroconductive polymer solution, which contains an electroconductive polymer having thiophene, aniline, pyrrole, or a derivative thereof as a repeating unit and a dopant or a salt thereof having an amide bond and an anion group as a result, may be produced.

In any methods, the reaction is preferably carried out in water or in an aqueous solution containing water and a water-miscible solvent because the polymerization liquid can be used as it is.

### [Electroconductive Polymer Material]

The electroconductive polymer material according to the present invention can be obtained by drying the electroconductive polymer solution according to the present invention. The electroconductive polymer material has a high electroconductivity. The temperature for drying the electroconductive polymer solution is not particularly limited, but can be, for example, 60° C. or higher and 300° C. or lower. Also, the time for drying the electroconductive polymer solution is not particularly limited, but can be, for example, 3 minutes or more and 300 minutes or less.

### [Solid Electrolytic Capacitor]

The solid electrolytic capacitor according to the present invention has a solid electrolyte layer containing the electroconductive polymer material according to the present invention. Since the electroconductive polymer material obtained by removing the solvent from the electroconductive polymer solution according to the present invention has a high electroconductivity, the solid electrolytic capacitor having a low ESR can be obtained. Note that, the solid electrolytic capacitor may contain an electrolytic solution other than solid electrolyte as the electrolyte.

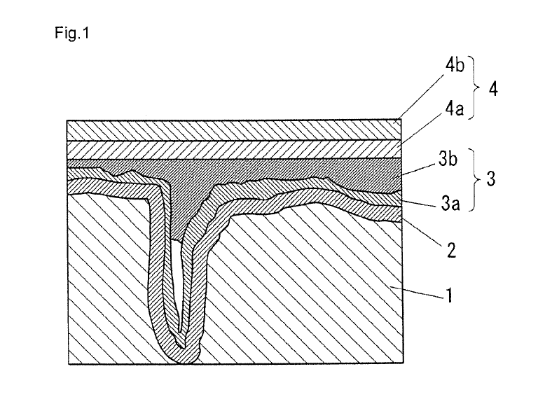

FIG. 1 shows a solid electrolytic capacitor according to one embodiment of the present invention. The solid electrolytic capacitor has a conformation in which dielectric layer 2, solid electrolyte layer 3, and cathode conductor 4 are laminated in this order on anode conductor 1. Note that, the solid electrolytic capacitor according to the present invention is not limited to this.

As anode conductor 1, a plate, a foil, or a wire of a valve metal; a sintered body containing a valve metal fine particle; a porous body metal subjected to a surface area enlargement treatment by etching; or the like can be used. Specific examples of the valve metal include tantalum, aluminum, titanium, niobium, zirconium, and alloys thereof. Among these, at least one selected from the group consisting of aluminum, tantalum, and niobium is preferable. Dielectric layer 2 can be formed by an electrolytic oxidation of anode conductor 1.

Examples of the method for forming solid electrolyte layer 3 include a method by an application or an impregnation of the electroconductive polymer solution according to the present invention on dielectric layer 2 and by a removal of the solvent from the electroconductive polymer solution. The application or impregnation method is not particularly limited. However, from the standpoint of sufficiently filling the electroconductive polymer solution into the porous pore inside, it is preferably left for several minutes to several ten minutes after the application or impregnation. Also, it is preferable that the immersion is repeatedly carried out and that a reduced-pressure system or a pressurized system is adopted.

The removal of the solvent from the electroconductive polymer solution can be carried out by drying the electroconductive polymer solution. The drying temperature is not particularly limited as long as it is in a temperature range at which the solvent can be removed, but is preferably 300° C. or lower from the standpoint of preventing the deterioration of the element by heat. The drying time can be appropriately selected depending on the drying temperature, but is not particularly limited as long as the electroconductivity is not decreased.

Also, solid electrolyte layer 3 can have two-layered conformation of first solid electrolyte layer 3a and second solid electrolyte layer 3b, as shown in FIG. 1. For example, first solid electrolyte layer 3a containing an electroconductive polymer is formed by a chemical oxidation polymerization or an electrolytic oxidation polymerization of a monomer giving an electroconductive polymer on dielectric layer 2. Second solid electrolyte layer 3b may be formed by an application or an impregnation of the electroconductive polymer solution according to the present invention on first solid electrolyte layer 3a and by a removal of the solvent from the electroconductive polymer solution. Also, first solid electrolyte layer 3a and second solid electrolyte layer 3b may be formed in reverse order.

Cathode conductor 4 may be formed on solid electrolyte layer 3. Cathode conductor 4 is not particularly limited as long as it is a conductor, but can have a two-layered conformation having graphite layer 4a and silver electroconductive resin layer 4b, as shown in FIG. 1.

### EXAMPLES

### Synthesis Example 1

### Aromatic Diamine Sulfonic Acid+Aromatic Dicarboxylic Acid

To a 100 ml three-necked round-bottom flask, 1.661 g (10 mmol) of isophthalic acid, 1.882 g (10 mmol) of 2,4-diaminobenzene sulfonic acid, 0.12 g of lithium chloride, 0.36 g of calcium chloride, 20 ml of N-methyl-2-pyrrolidone, 3 ml of pyridine, and 6.2 g of triphenyl phosphite were added. This was reacted under dry nitrogen atmosphere at 100° C. for 4 hours to obtain a polymer solution. After the reaction finished, the polymer solution was poured into 1 liter of methanol to precipitate a polymer. After the filtration of the solution in which the polymer was precipitated, unreacted monomers and inorganic metal salts were removed in hot methanol. After the filtration of this solution, it was vacuum-dried to obtain a dopant having an amide bond and an anion group according to the present invention.

The dopant having an amide bond and an anion group was soluble in water. The weight average molecular weight of the dopant having an amide bond and an anion group was 60000. The ratio of the aromatic ring contained in the main chain of the dopant having an amide bond and an anion group was 100%. The ratio of the aromatic ring substituted by an anion group in the main chain of the dopant having an amide bond and an anion group was 50%. The content of the anion group in the dopant or the salt thereof having an amide bond and an anion group was 50%.

### Synthesis Example 2

### Aromatic Diamine+Aromatic Dicarboxylic Acid Sulfonic Acid

To a 100 ml three-necked round-bottom flask, 2.462 g (10 mmol) of 3,5-dicarboxy benzenesulfonic acid, 1.081 g (10 mmol) of 1,3-diaminobenzene, 0.12 g of lithium chloride, 0.36 g of calcium chloride, 20 ml of N-methyl-2-pyrrolidone, 3 ml of pyridine, and 6.2 g of triphenyl phosphite were added. After that, the operations were carried out in the same manner as in Synthesis Example 1 to obtain a dopant having an amide bond and an anion group according to the present invention.

The dopant having an amide bond and an anion group was soluble in water. The weight average molecular weight of the dopant having an amide bond and an anion group was 60000. The ratio of the aromatic ring contained in the main chain of the dopant having an amide bond and an anion group was 100%. The ratio of the aromatic ring substituted by an anion group in the main chain of the dopant having an amide bond and an anion group was 50%. The content of the anion group in the dopant or the salt thereof having an amide bond and an anion group was 50%.

### Synthesis Example 3

### Aromatic Diamine Sulfonic Acid+Aromatic Diamine+Aromatic Dicarboxylic Acid

To a 100 ml three-necked round-bottom flask, 1.661 g (10 mmol) of isophthalic acid, 0.941 g (5 mmol) of 2,4-diaminobenzene sulfonic acid, 0.541 g (5 mmol) of 1,3-diaminobenzene, 0.12 g of lithium chloride, 0.36 g of calcium chloride, 20 ml of N-methyl-2-pyrrolidone, 3 ml of pyridine, and 6.2 g of triphenyl phosphite were added. After that, the operations were carried out in the same manner as in Synthesis Example 1 to obtain a dopant having an amide bond and an anion group according to the present invention.

The dopant having an amide bond and an anion group was soluble in water. The weight average molecular weight of the dopant having an amide bond and an anion group was 60000. The ratio of the aromatic ring contained in the main chain of the dopant having an amide bond and an anion group was 100%. The ratio of the aromatic ring substituted by an anion group in the main chain of the dopant having an amide bond and an anion group was 25%. The content of the anion group in the dopant or the salt thereof having an amide bond and an anion group was 25%.

### Synthesis Example 4

### Aliphatic Diamine+Aromatic Dicarboxylic Acid Sulfonic Acid

To a 100 ml three-necked round-bottom flask, 2.462 g (10 mmol) of 3,5-dicarboxy benzenesulfonic acid, 1.162 g (10 mmol) of 1,6-hexanediamine, 0.12 g of lithium chloride, 0.36 g of calcium chloride, 20 ml of N-methyl-2-pyrrolidone, 3 ml of pyridine, and 6.2 g of triphenyl phosphite were added. After that, the operations were carried out in the same manner as in Synthesis Example 1 to obtain a dopant having an amide bond and an anion group according to the present invention.

The dopant having an amide bond and an anion group was soluble in water. The weight average molecular weight of the dopant having an amide bond and an anion group was 55000. The ratio of the aromatic ring contained in the main chain of the dopant having an amide bond and an anion group was 50%. The ratio of the aromatic ring substituted by an anion group in the main chain of the dopant having an amide bond and an anion group was 100%. The content of the anion group in the dopant or the salt thereof having an amide bond and an anion group was 50%.

### Synthesis Example 5

### Aliphatic Dicarboxylic Acid+Aromatic Diamine Sulfonic Acid

To a 100 ml three-necked round-bottom flask, 1.461 g (10 mmol) of adipic acid, 1.882 g (10 mmol) of 2,4-diaminobenzenesulfonic acid, 0.12 g of lithium chloride, 0.36 g of calcium chloride, 20 ml of N-methyl-2-pyrrolidone, 3 ml of pyridine, and 6.2 g of triphenyl phosphite were added. After that, the operations were carried out in the same manner as in Synthesis Example 1 to obtain a dopant having an amide bond and an anion group according to the present invention.

The dopant having an amide bond and an anion group was soluble in water. The weight average molecular weight of the dopant having an amide bond and an anion group was 55000. The ratio of the aromatic ring contained in the main chain of the dopant having an amide bond and an anion group was 50%. The ratio of the aromatic ring substituted by an anion group in the main chain of the dopant having an amide bond and an anion group was 100%. The content of the anion group in the dopant or the salt thereof having an amide bond and an anion group was 50%.

### Synthesis Example 6

### Aromatic Diamine+Aromatic Dicarboxylic Acid Sulfonic Acid+Aromatic Dicarboxylic Acid

To a 100 ml three-necked round-bottom flask, 1.231 g (5 mmol) of 3,5-dicarboxy benzenesulfonic acid, 0.831 g (5 mmol) of isophthalic acid, 1.081 g (10 mmol) of 1,3-diaminobenzene, 0.12 g of lithium chloride, 0.36 g of calcium chloride, 20 ml of N-methyl-2-pyrrolidone, 3 ml of pyridine, and 6.2 g of triphenyl phosphite were added. After that, the operations were carried out in the same manner as in Synthesis Example 1 to obtain a dopant having an amide bond and an anion group according to the present invention.

The dopant having an amide bond and an anion group was soluble in water. The weight average molecular weight of the dopant having an amide bond and an anion group was 60000. The ratio of the aromatic ring contained in the main chain of the dopant having an amide bond and an anion group was 100%. The ratio of the aromatic ring substituted by an anion group in the main chain of the dopant having an amide bond and an anion group was 25%. The content of the anion group in the dopant or the salt thereof having an amide bond and an anion group was 25%.

### Synthesis Example 7

### Lactam+Aromatic Dicarboxylic Acid Sulfonic Acid+Aliphatic Diamine+Compound Having an Anion Group and an Amino Group

To a 100 ml three-necked round-bottom flask, 1.131 g (10 mmol) of ε-caprolactam, 0.246 g (1 mmol) of 3,5-dicarboxy benzenesulfonic acid, 0.116 g (1 mmol) of 1,6-hexanediamine, and 3.0 g of water were added, and it was mixed. To this mixed liquid, 0.014 g (0.11 mmol) of 6-aminocaproic acid was added, and it was heated to 75° C. to prepare a uniform solution. After a nitrogen gas introduction tube was attached to the three-necked round-bottom flask, the solution was heated from 150° C. to 240° C. at a rate of 15° C./10 minutes with flowing small amount of nitrogen gas. After that, the solution was kept at 240° C. for 6 hours to obtain a dopant having an amide bond and an anion group according to the present invention.

The dopant having an amide bond and an anion group was soluble in water. The weight average molecular weight of the dopant having an amide bond and an anion group was 10000. The ratio of the aromatic ring contained in the main chain of the dopant having an amide bond and an anion group was 8.3%. The ratio of the aromatic ring substituted by an anion group in the main chain of the dopant having an amide bond and an anion group was 100%. The content of the anion group in the dopant or the salt thereof having an amide bond and an anion group was 8.3%.

### Synthesis Example 8

### Change of Sulfonated Ratio

To a 100 ml three-necked round-bottom flask, 1.661 g (10 mmol) of isophthalic acid, 0.1882 g (1 mmol) of 2,4-diaminobenzenesulfonic acid, 0.973 g (9 mmol) of 1,3-diaminobenzene, 0.12 g of lithium chloride, 0.36 g of calcium chloride, 20 ml of N-methyl-2-pyrrolidone, 3 ml of pyridine, and 6.2 g of triphenyl phosphite were added. After that, the operations were carried out in the same manner as in Synthesis Example 1 to obtain a dopant having an amide bond and an anion group according to the present invention.

The dopant having an amide bond and an anion group was soluble in water. The weight average molecular weight of the dopant having an amide bond and an anion group was 60000. The ratio of the aromatic ring contained in the main chain of the dopant having an amide bond and an anion group was 100%. The ratio of the aromatic ring substituted by an anion group in the main chain of the dopant having an amide bond and an anion group was 5%. The content of the anion group in the dopant or the salt thereof having an amide bond and an anion group was 5%.

### Synthesis Example 9

### Lactam+1,3,5-Pentanetricarboxylic Acid+1,6-Hexanediamine

To a 100 ml three-necked round-bottom flask, 1.131 g (10 mmol) of ε-caprolactam, 0.204 g (1 mmol) of 1,3,5-pentanetricarboxylic acid, 0.116 g (1 mmol) of 1,6-hexanediamine, and 3.0 g of water were added, and it was mixed. To this mixed liquid, 0.014 g (0.11 mmol) of 6-aminocaproic acid was added, and it was heated to 75° C. to prepare a uniform solution. After a nitrogen gas introduction tube was attached to the three-necked round-bottom flask, the solution was heated from 150° C. to 240° C. at a rate of 15° C./10 minutes with flowing small amount of nitrogen gas. After that, the solution was kept at 240° C. for 6 hours to obtain a dopant having an amide bond and an anion group according to the present invention.

The weight average molecular weight of the dopant having an amide bond and an anion group was 7000. The ratio of the aromatic ring contained in the main chain of the dopant having an amide bond and an anion group was 0%. The ratio of the aromatic ring substituted by an anion group in the main chain of the dopant having an amide bond and an anion group was 0%. The content of the anion group in the dopant or the salt thereof having an amide bond and an anion group was 8.3%.

### Example 1

2 g of the dopant having an amide bond and an anion group synthesized in Synthesis Example 1, 0.5 g of 3,4-ethylenedioxythiophene, 0.05 g of iron (III) sulfate, 2 g of ammonium persulfate as an oxidant were dissolved in 20 ml of water. Air was introduced into this solution for 24 hours, and then the solution was passed through a filter of 1 μm pore diameter to obtain a polythiophene solution. 100 μl of the polythiophene solution was dropped on a glass substrate, and it was dried in a thermostatic oven at 125° C. to form an electroconductive polymer film. The surface resistance (Ω/□) and the film thickness of the electroconductive polymer film were measured by four-terminal method (product name: Loresta GP-MCT-T610, made by Mitsubishi Chemical Corporation), and the electroconductivity (S/cm) of the electroconductive polymer film was calculated. The result is shown in TABLE 1.

### Example 2

A polythiophene solution was prepared and the electroconductivity thereof was calculated in the same manner as in Example 1 except that the dopant having an amide bond and an anion group which was synthesized in Synthesis Example 2 was used. The result is shown in TABLE 1.

### Example 3

A polythiophene solution was prepared and the electroconductivity thereof was calculated in the same manner as in Example 1 except that the dopant having an amide bond and an anion group which was synthesized in Synthesis Example 3 was used. The result is shown in TABLE 1.

### Example 4

A polythiophene solution was prepared and the electroconductivity thereof was calculated in the same manner as in Example 1 except that the dopant having an amide bond and an anion group which was synthesized in Synthesis Example 4 was used. The result is shown in TABLE 1.

### Example 5

A polythiophene solution was prepared and the electroconductivity thereof was calculated in the same manner as in Example 1 except that the dopant having an amide bond and an anion group which was synthesized in Synthesis Example 5 was used. The result is shown in TABLE 1.

### Example 6

A polythiophene solution was prepared and the electroconductivity thereof was calculated in the same manner as in Example 1 except that the dopant having an amide bond and an anion group which was synthesized in Synthesis Example 6 was used. The result is shown in TABLE 1.

### Example 7

A polythiophene solution was prepared and the electroconductivity thereof was calculated in the same manner as in Example 1 except that the dopant having an amide bond and an anion group which was synthesized in Synthesis Example 7 was used. The result is shown in TABLE 1.

### Example 8

A polythiophene solution was prepared and the electroconductivity thereof was calculated in the same manner as in Example 1 except that the dopant having an amide bond and an anion group which was synthesized in Synthesis Example 8 was used. The result is shown in TABLE 1.

### Example 9

A polythiophene solution was prepared and the electroconductivity thereof was calculated in the same manner as in Example 1 except that the dopant having an amide bond and an anion group which was synthesized in Synthesis Example 9 was used. The result is shown in TABLE 1.

### Example 10

A polythiophene solution was prepared and the electroconductivity thereof was calculated in the same manner as in Example 1 except that a sulfonated polyamide with a weight average molecular weight of 1000 was used instead of the dopant having an amide bond and an anion group which was synthesized in Synthesis Example 1. The result is shown in TABLE 1.

Note that, the ratio of the aromatic ring contained in the main chain of the sulfonated polyamide was 50%. The ratio of the aromatic ring substituted by an anion group in the main chain of the sulfonated polyamide was 100%. The content of the anion group in the sulfonated polyamide was 50%.

### Example 11

A polythiophene solution was prepared and the electroconductivity thereof was calculated in the same manner as in Example 1 except that a sulfonated polyamide with a weight average molecular weight of 550000 was used instead of the dopant having an amide bond and an anion group which was synthesized in Synthesis Example 1. The result is shown in TABLE 1.

Note that, the ratio of the aromatic ring contained in the main chain of the sulfonated polyamide was 50%. The ratio of the aromatic ring substituted by an anion group in the main chain of the sulfonated polyamide was 100%. The content of the anion group in the sulfonated polyamide was 50%.

### Example 12

A polythiophene solution was prepared and the electroconductivity thereof was calculated in the same manner as in Example 1 except that a sulfonated polyamide with a weight average molecular weight of 700 was used instead of the dopant having an amide bond and an anion group which was synthesized in Synthesis Example 1. The result is shown in TABLE 1.

Note that, the ratio of the aromatic ring contained in the main chain of the sulfonated polyamide was 50%. The ratio of the aromatic ring substituted by an anion group in the main chain of the sulfonated polyamide was 100%. The content of the anion group in the sulfonated polyamide was 50%.

### Example 13

A polypyrrole solution was prepared and the electroconductivity thereof was calculated in the same manner as in Example 1 except that pyrrole was used instead of 3,4-ethylenedioxythiophene. The result is shown in TABLE 1.

### Example 14

1 g of 3,4-ethylenedioxythiophene and 1 g of camphorsulfonic acid as a dopant were dispersed in 100 ml of water. This dispersion was stirred at room temperature for 1 hour. After that, 2.4 g of ammonium persulfate as an oxidant was added to this dispersion. The dispersion obtained was stirred at room temperature for 100 hours to carry out a chemical oxidation polymerization.

Powders were collected from the dispersion obtained using a centrifugal machine (5,000 rpm). The powders were washed by decantation method with the centrifugal machine using pure water to remove excess oxidant and dopant. The washing by pure water was repeated until the acidity of the supernatant liquid came to be pH 6 to 7.

0.5 g of the purified powders was dispersed in 50 ml of water. After that, 3 g of the dopant having an amide bond and an anion group synthesized in Synthesis Example 1 were added to this dispersion, and they were mixed. 1.5 g of ammonium persulfate as an oxidant was added to this mixture liquid, and it was stirred at room temperature for 24 hours. The polythiophene suspension obtained was navy blue.

An electroconductive polymer film was formed and the electroconductivity thereof was calculated in the same manner as in Example 1. The result is shown in TABLE 1.

### Comparative Example 1

### PEDOT/PSS

2 g of a polystyrene sulfonic acid (weight average molecular weight: 5,000), 0.5 g of 3,4-ethylenedioxythiophene, 0.05 g of iron (III) sulfate, and 2 g of ammonium persulfate as an oxidant were dissolved in 20 ml of water. Air was introduced into this solution for 24 hours to prepare a polythiophene solution. After that, an electroconductive polymer film was formed and the electroconductivity thereof was calculated in the same manner as in Example 1. The result is shown in TABLE 1.

### Comparative Example 2

### PEDOT/PSS

A polythiophene solution was prepared in the same manner as in Comparative Example 1 except that a polystyrene sulfonic acid having a weight average molecular weight of 50,000 was used. After that, an electroconductive polymer film was formed and the electroconductivity thereof was calculated in the same manner as in Example 1. The result is shown in TABLE 1.

### Example 15

### Al Capacitor Production, One-Layered

A porous aluminum was used as an anode conductor containing a valve metal. An oxide film that was a dielectric layer was formed on the surface of the aluminum by conducting an anodic oxidation of the anode conductor. Then, the anode conductor on which the dielectric layer was formed was immersed in the polythiophene solution synthesized in Example 1, and it was pulled up. After that, it was dried and solidified at 125° C. to form a solid electrolyte layer. A graphite layer and a silver-containing resin layer were formed in this order on the solid electrolyte layer to obtain a solid electrolytic capacitor. The ESR (equivalent series resistance) of the solid electrolytic capacitor obtained was measured at a frequency of 100 kHz using an LCR meter. The ESR value was standardized from the total area of the cathode portion to a unit area (1 cm²). The result is shown in TABLE 2.

### Example 16

### Al Capacitor Production, Two-Layered

A porous aluminum was used as an anode conductor containing a valve metal. An oxide film that was a dielectric layer was formed on the surface of the aluminum by conducting an anodic oxidation of the anode conductor. Then, the anode conductor on which the dielectric layer was formed was immersed in a monomer liquid obtained by dissolving 10 g of pyrrole as a monomer (M2) in 200 ml of pure water, and it was pulled up. After that, the anode conductor was immersed in an oxidant liquid obtained by dissolving 20 g of p-toluenesulfonic acid as a dopant and 10 g of ammonium persulfate as an oxidant in 200 ml pure water, and it was pulled up. These immersing and pulling up steps against this monomer solution and the oxidant liquid were alternately repeated 10 times and a chemical oxidation polymerization was carried out to form a first solid electrolyte layer. The polythiophene solution synthesized in Example 1 was dropped on the first solid electrolyte layer. This was dried and solidified at 125° C. to form a second solid electrolyte layer. A graphite layer and a silver-containing resin layer were formed in this order on the second solid electrolyte layer to obtain a solid electrolytic capacitor. The ESR (equivalent series resistance) of the solid electrolytic capacitor obtained was measured in the same manner as in Example 15. The result is shown in TABLE 2.

### Example 17

### Ta Capacitor Production, Two-Layered

A solid electrolytic capacitor was produced and the ESR (equivalent series resistance) was measured in the same manner as in Example 16 except that a porous tantalum was used as the anode conductor containing a valve metal. The result is shown in TABLE 2.

### Example 18

### Al Capacitor Production, Two-Layered

A solid electrolytic capacitor was produced and the ESR (equivalent series resistance) was measured in the same manner as in Example 16 except that the polythiophene solution prepared in Example 6 was used. The result is shown in TABLE 2.

### Comparative Example 3

### Al Capacitor Production, Two-Layered

A solid electrolytic capacitor was produced and the ESR (equivalent series resistance) was measured in the same manner as in Example 16 except that the polythiophene solution prepared in Comparative Example 2 was used. The result is shown in TABLE 2.

TABLE 1

| | electroconductivity |
|---|---|
| | (S/cm) |
| Ex. 1 | 183 |
| Ex. 2 | 178 |
| Ex. 3 | 168 |
| Ex. 4 | 150 |
| Ex. 5 | 148 |
| Ex. 6 | 162 |
| Ex. 7 | 131 |
| Ex. 8 | 136 |
| Ex. 9 | 121 |
| Ex. 10 | 129 |
| Ex. 11 | 186 |
| Ex. 12 | 116 |
| Ex, 13 | 131 |
| Ex. 14 | 192 |
| Comp. Ex. 1 | 98 |
| Comp. Ex. 2 | 112 |

TABLE 2

| | ESR |
|---|---|
| | (mΩ · cm²) |
| Ex. 15 | 1.9 |
| Ex. 16 | 1.7 |
| Ex. 17 | 1.7 |
| Ex. 18 | 1.6 |
| Comp. Ex. 3 | 3.1 |

### INDUSTRIAL APPLICABILITY

The electroconductive polymer solution according to the present invention can be used for antistatic films, transparent electroconductive films (ITO alternative materials), organic ELs, anti-rust materials, and solar cells.

### REFERENCE SIGNS LIST

1 anode conductor
2 dielectric layer
3 solid electrolyte layer
3a first solid electrolyte layer
3b second solid electrolyte layer
4 cathode conductor
4a graphite layer
4b silver electroconductive resin layer

What is claimed is:

1. An electroconductive polymer solution, comprising an electroconductive polymer comprising thiophene, aniline, pyrrole, or a derivative thereof as a repeating unit, wherein a dopant or a salt thereof having an amide bond and an anion group is doped into the electroconductive polymer.

2. The electroconductive polymer solution according to claim 1, wherein the anion group is at least one functional group selected from the group consisting of sulfo group, carboxyl group, and phosphoric acid group.

3. The electroconductive polymer solution according to claim 1, wherein a weight average molecular weight of the dopant or the salt thereof having an amide bond and an anion group is 1000 to 5000000.

4. The electroconductive polymer solution according to claim 1, wherein the dopant or the salt thereof having an amide bond and an anion group has a main chain comprising an amide bond.

5. The electroconductive polymer solution according to claim 1, wherein the dopant or the salt thereof having an amide bond and an anion group is a copolymer of monomers comprising multivalent amine or derivative thereof (a) and multivalent carboxylic acid or derivative thereof (b).

6. The electroconductive polymer solution according to claim 5, wherein multivalent amine or derivative thereof (a) is at least one selected from the group consisting of 1,3-diaminopropane, 1,4-diaminobutane, 1,5-diaminopentane, 1,6-diaminohexane, 1,7-diaminoheptane, 1,8-diaminooctane, 1,9-diaminononane, p-phenylenediamine, m-phenylenediamine, and o-phenylenediamine, and a derivative thereof.

7. The electroconductive polymer solution according to claim 5, wherein multivalent carboxylic acid or derivative thereof (b) is at least one selected from the group consisting of oxalic acid, malonic acid, succinic acid, glutaric acid, adipic acid, pimelic acid, suberic acid, azelaic acid, sebacic acid, terephthalic acid, isophthalic acid, o-phthalic acid, and a derivative thereof.

8. The electroconductive polymer solution according to claim 1, wherein the dopant or the salt thereof having an amide bond and an anion group has a main chain comprising an aromatic ring.

9. The electroconductive polymer solution according to claim 8, wherein at least a part of the aromatic ring is substituted with an anion group.

10. The electroconductive polymer solution according to claim 8, wherein 5% or more of the aromatic ring is substituted with an anion group.

11. The electroconductive polymer solution according to claim 1, further comprising a polystyrene sulfonic acid.

12. The electroconductive polymer solution according to claim 1, further comprising an aprotic polar solvent.

13. The electroconductive polymer solution according to claim 1, further comprising a binder.

14. An electroconductive polymer material, obtained by drying the electroconductive polymer solution according to claim 1.

15. A solid electrolytic capacitor, comprising a solid electrolyte layer comprising the electroconductive polymer material according to claim 14.

16. A method for producing an electroconductive polymer solution, comprising carrying out an oxidation polymerization of thiophene, aniline, pyrrole, or a derivative thereof in water or in an aqueous solution comprising water and a water-miscible solvent in the presence of a dopant or a salt thereof having an amide bond and an anion group.

17. A method for producing an electroconductive polymer solution, comprising:
obtaining electroconductive polymer (P1) by an oxidation polymerization of thiophene, aniline, pyrrole, or a derivative thereof in a solution comprising a low-molecular organic acid or a salt thereof that is a dopant;
purifying electroconductive polymer (P1); and
obtaining an electroconductive polymer solution by mixing purified electroconductive polymer (P1) and oxidant (O2) in a solution comprising a dopant or a salt thereof having an amide bond and an anion group.
